(19) United States
(12) Patent Application Publication
(10) Pub. No.: US 2024/0370804 A1
(43) Pub. Date: Nov. 7, 2024

(54) SYSTEMS AND METHODS FOR BUILDING EDUCATIONAL COURSES

(71) Applicant: COURSERA, INC., Mountain View, CA (US)

(72) Inventors: Jennifer Wolochow, Seattle, WA (US); Ronojoy Bhaumik, Toronto (CA); John Austin Greene, San Francisco, CA (US); Eric Lin, Mountain View, CA (US)

(21) Appl. No.: 18/634,722

(22) Filed: Apr. 12, 2024

Related U.S. Application Data
(60) Provisional application No. 63/495,753, filed on Apr. 12, 2023.

(51) Int. Cl. G06Q 10/0637; G06F 16/332; G06Q 50/20

(52) U.S. Cl. CPC G06Q 10/0637; G06F 16/332; G06Q 50/205

(57) ABSTRACT

A description of an educational course can be received and a first LLM can be prompted, based on the description of the educational course, to generate an outline for the educational course, the outline including a plurality of modules for the educational course and descriptions of the modules, each description of a module of the plurality of modules including one or more learning objectives for the module, Based on the learning objectives for the modules, search queries for searching a database of course content can be generated. Candidate course content responsive to the search queries being executed on the database can be received from a database of existing course content. Based on the description of the educational course, a second LLM can be prompted to organize at least a subset of the candidate course content to generate the educational course, and the generated educational course can be received.

### CROSS-REFERENCE TO RELATED APPLICATION

This application claims priority to U.S. Provisional Application No. 63/495,753, filed on Apr. 12, 2023, and entitled “SYSTEMS AND METHODS FOR CUSTOMIZING EDUCATIONAL COURSES,” the disclosure of which is incorporated by reference herein in its entirety.

### TECHNICAL FIELD

This description relates to online learning systems and, in particular, to systems and methods for building educational courses.

### BACKGROUND

Online learning platforms provide network-based educational opportunities for users, which would otherwise be inconvenient or unavailable for those users. As an addition to the benefits of the online learning platforms, the hands-on learning experience allows users to acquire skills through an active-learning approach. For example, a hands-on learning experience may include learning to write functional code.

Courses presented on online learning platforms provide extensive learning opportunities to diverse groups of students. The benefits of education delivery over online networks to diverse groups of students can be further advanced by customizing the courses for individual students or individual groups of students, or for individual situations.

Creating an educational course can involve considerable expenditure of time and effort by the author of the course, for example, in creating and/or collecting and organizing course items (text, slides, video, quizzes, homework assignments, etc.) and in preparing lecture transcripts, etc. In some cases, this effort can be time- and cost-prohibitive for creating a new course that might be customized to a group of learners or customized for achieving particular learning goals in a course. Therefore, a need for the ability to create new and customized high-quality courses exists.

### SUMMARY

According to some general aspects, a computer program product may be tangibly embodied on a non-transitory computer-readable storage medium and may include instructions. When executed by at least one computing device, the instructions may be configured to cause the at least one computing device to receive a description of an educational course and to prompt, based on the description of the educational course, a first large language model (LLM) to generate an outline for the educational course, the outline including a plurality of modules for the educational course and descriptions of the modules, each description of a module of the plurality of modules including one or more learning objectives for the module. When executed by at least one computing device, the instructions may be further configured to cause the at least one computing device to generate, based on the one or more learning objectives for the modules, search queries for searching a database of course content. When executed by at least one computing device, the instructions may be further configured to cause the at least one computing device to receive candidate course content from a database of existing course content, the candidate course content being responsive to the search queries being executed on the database. When executed by at least one computing device, the instructions may be further configured to cause the at least one computing device to prompt, based on the description of the educational course, a second LLM to organize at least a subset of the candidate course content to generate the educational course and to receive the generated educational course.

Implementations can include one or more of the following features, alone, or in any combination with each other.

For example, the description of the course can include a target duration for the course.

In another example, the duration of the generated course can have a duration of within a threshold range of the target duration of the course.

In another example, the description of the course can further include one or more of: a topic of the course, a target audience for the course, and learning objectives for the course.

In another example, the first LLM can be prompted to generate outlines of educational courses that adhere to a taxonomy that classifies the learning objectives by complexity and specificity and in which content of each module is ordered according to increasing levels of complexity.

In another example, the received candidate course content can include course content that matches one or more of the search queries and parent and/or child course content of the course content that matches the one or more search queries.

In another example, the candidate course content received from the database of existing course content can include candidate course content received from a plurality of separate and distinct courses from the database of existing course content, and the generated educational course can include course content from a plurality of separate and distinct courses from the database of existing course content.

In another example, the second LLM can be prompted to generate the educational course that includes the subset of the candidate course content, where the subset of the candidate course content is organized in the generated course according to a taxonomy that classifies learning objectives associated with the candidate course content by complexity and specificity and in which course content of each module of the generated course is ordered according to increasing levels of complexity.

According to other general aspects, computer-implemented methods may perform the instructions of the computer program product, including any of its example features. According to other general aspects, a system may include at least one memory, including instructions, and at least one processor that is operably coupled to the at least one memory and that is arranged and configured to execute instructions that, when executed, cause the at least one processor to perform the instructions of the computer program product, including any of its example features, and/or the operations of the computer-implemented methods.

The details of one or more implementations are set forth in the accompanying drawings and the description below. Other features will be apparent from the description and drawings, and from the claims.

### BRIEF DESCRIPTION OF THE DRAWINGS

FIGS. 1A and 1B show a flowchart of a method for authoring content of a customized educational course.

FIG. 2 is a schematic block diagram of a system for creating an educational course to be provided to a plurality of learners from an online platform.

FIGS. 3A and 3B are an example schematic diagram of a workflow for creating an educational course by using LLMs to retrieve course content from existing courses within database repositories of an online learning platform and to integrate the retrieved content to create the course.

FIG. 4 is a flowchart of a process.

FIGS. 5A-5D show a flowchart of a method for authoring content of a customized educational course by using LLMs to retrieve course content from existing courses within database repositories of an online learning platform and to integrate the retrieved content to create the course.

### DETAILED DESCRIPTION

In a massive online learning platform, authoring an educational course can take advantage of existing course content that is available on the platform to create a new course that includes, or that is based on, the existing course content. For example, the online learning platform can maintain a database of thousands, or tens of thousands, of individual courses, and each course can include many individual modules, which, in turn, can include many individual items. An author of a new course can draw the material in the database to create a new course. However, with existing techniques searching the database for content relevant to the topic and learning goals for the new course and assembling the content into a new course often can be more time-consuming than authoring a new course from scratch, and the author may not be able to integrate the content from the database of the online learning platform into the new course in a logical and cohesive manner.

As described herein, large language models (LLMs) and generative artificial intelligence (AI) tools can be used to effectively extract relevant content from the courses stored in the database of the online learning platform and to integrate the content into a new course in a logical and cohesive manner, so that the new course provides a high-quality learning experience for learners and achieves the learning goals of the author. Systems and methods using Artificial Intelligence (AI) tools can make authoring a customized education course easier and less burdensome than the manual efforts by the author of the customized education course.

In example implementations, an author can be prompted to input information about a topic, or title, of the new course, a duration of the new course, a target audience for the new course, and learning objectives for the new course. The author also may be prompted to input content for the course that may not be stored in the database of the online platform. Based on the inputs from the author, an LLM can generate a draft course outline for the new course, where the draft outline includes descriptions of a plurality of modules to be included in the course, where the descriptions of each module can include one or more items or sub-modules to be included in the module, and descriptions of learning objectives for the module and its items and sub-modules. The descriptions for the parts of the outline then can be used to generate search terms and keywords that are used to search for relevant content in the online database. Highly-ranked search results then can be used as the foundational building blocks for the new course. An LLM can analyze the highly-ranked search results and, based on the analysis, can assemble portions of the content from the search results into a course, where the assembly of content can use pedagogical best practices to ensure that the content of the course is presented in an clear and understandable manner, to the target audience for the course, within the desired duration for the course, and achieves the learning objectives for the course.

A course authoring system (CAS) (hosted on a computer system or a network of computer systems) may include or be coupled to an AI tool. The CAS may be coupled to an external AI tool, for example, through an API. The CAS may include user interfaces (UI) (e.g., keyboard, microphones, UI text input boxes on a display, etc.) through which an author (e.g., an instructor or educator) can interact with the CAS and AI tool to customize a course.

The author may, for example, indicate to the CAS what she wants the course to be about and what learning objectives she wants the learners to gain from the course. The author may, for example, submit (e.g., in a UI text box) that the course is a leadership course covering skills like communication team building, diversity, equity, and inclusion. The author may further upload supplemental content for the course (for example, by providing links to, or uploads of, recordings of previous lectures, training sessions or written documents like a syllabus or a list of skills that she has previously prepared or used). The author may also indicate that she would like the CAS system to access partner or private databases that may be repositories of previously prepared courses or other information for the purpose of using course content from the partner or private databases to include in the generated course.

The CAS may generate a customized course for the author based on the AI tool output (e.g., a leadership course covering skills including communication team building and diversity equity). The author may seek to include additional material (e.g., video clips) from participating partner or private databases to supplement her privately customized course (e.g., to make it more interesting and relevant to her learners), and the AI tool output may be based on course content materials that are sourced from the private or partner databases and on the supplemental content uploaded to the CAS by the author. The CAS may analyze the author's inputs and generate course content based on the author's inputs. The CAS may recommend existing course content that may be available in an accessible existing course repository to include in the course, to generate a draft (e.g., a prototype) of the customized course for the author. The CAS may apply pedagogical best practices in preparing the customized course for the author.

The CAS may present the draft or prototype of the customized course to the author for review and curation. The author may review all course components and edit the content. For example, CAS may (on a review UI) present a video that was uploaded as supplemental content by the author and is now included in the draft. For review, the uploaded video may be split into shorter clips and listed alongside videos from other authors on the review UI. The review UI may also include additional information associated with the videos (e.g., a reading glossary and a practice assignment). The displays may include autogenerated summaries of the videos based, for example, on the content of the videos. The autogenerated summaries derived from the transcript may include highlights that the viewer can use to jump to each video segment. The author may quickly review a video by reading the summary or by jumping to the highlighted segments of the video to get a quick sense of the video. The author may decide which ones (or none) of the listed videos to use in the course. The author may also instruct the CAS to search specifically for other content. The author can select which video clips to use in the course to supplement the course reading.

The CAS may autogenerate a glossary of keywords to accompany the video clips (and all other components of the course). The glossary of key words may include an assignment or attribution, for example, of the owner or original source of the video clip or other course item. A viewer of the course may use the attribution to identify the owner or original source of the video clip or the other course item.

In some implementations, the CAS may autogenerate a course name, description, a list of skills taught, and a logo for the customized course for the author.

The draft customized course generated by the CAS may be further curated (e.g., automatically by the CAS, and/or with the author's intervention through the review UI) to ensure that the structure of the customized course confirms to course structure standards (e.g., specific best practice pedagogical standards and formats) of the author or the author's organization (which, for example, may be an online course provider). Courses by the author-organization's standards may, for example, include modules with module names, descriptions of the content and the learning objectives of each module. The modules may be presented to a student at a rate of about three modules each month along with some work assignments and quizzes (e.g., homework).

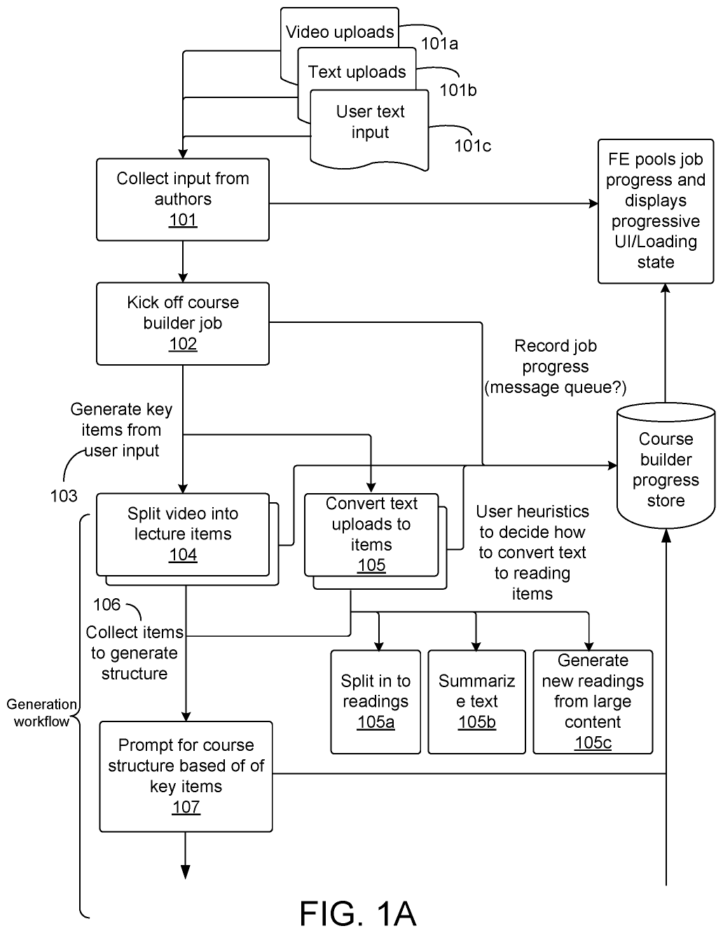

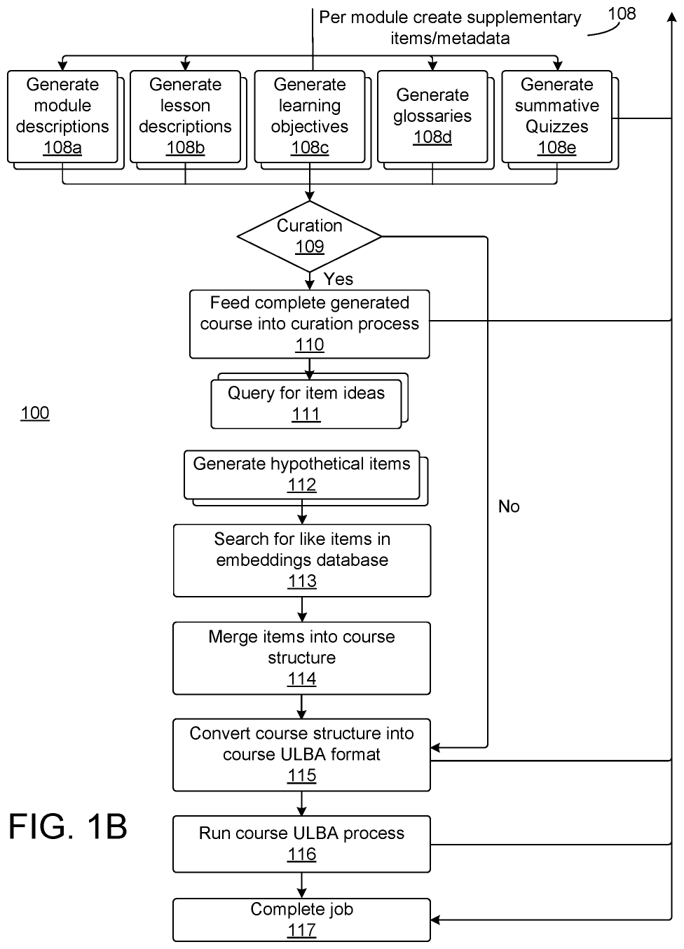

FIGS. 1A and 1B show a flowchart of a process 100 for authoring a course with AI assistance using the course authoring system (CAS) described above.

Process 100, at stage 101, may include collecting input from an author. The collected input may, for example, include video uploads 101a, text uploads 101b, and/or user text input 101c. Supported file types for upload may include video, audio, doc, PDF, PPT, csv, etc.

Process 100 may further include, at stage 102, kicking off (i.e., launching) a course builder job; and at stage 103, generating key items (for inclusion in the course) from the user input. Generating key items from the user input may include, at stage 104, splitting a video into lecture items, and at stage 105, converting text uploads into items. Converting text uploads into items may use heuristics to convert text into items, for example, to split text into readings 105a, summarize text 105b, and generate new readings from large content 105c.

Process 100 may further include, at stage 107, prompting for course structure based on the key items; and at stage 108, creating supplementary items and/or meta data for each module in the course. Creating supplementary items and/or meta data for each course module may include, generating module description 108a; generating lesson descriptions 108b; generating learning objectives 108c; generating glossaries 108d; and generating summative quizzes 108e. This may complete a generation workflow in the CAS system and result in the “generative” draft or prototype course prepared with AI assistance.

Next, in process 100, at stage 109, a decision may be made whether the generative draft or prototype course should undergo curation. If not, the generative draft or prototype course prepared with AI assistance proceeds to stage 115 of process 100 where the course structure is converted into a course upload-based authoring (ULBA) format (of the author's organization).

If in process 100, at stage 109, a decision that the generative draft or prototype course should undergo curation is yes, the generative draft or prototype course completed with AI assistance is at stage 110 fed into a curation process. The curation process can involve querying for course item ideas (stage 111), generating hypothetical course items (stage 112), and searching for the items in an embeddings database (113). The embedding database may include the author-organization's course repository. In process 100, next at stage 114, the items are merged (automatically by the CAS or upon author intervention) into the course structure. At stage 115, the curated merged course structure (like the un-curated course structure from stage 108) is converted into a course format of the author's organization.

Further, at stage 116, a course ULBA process is run to place or upload all items in a proper format in the course structure. Thus, at stage 117, process 100 completes the course builder job started at stage 102. The completed course structure is ready for publication by the author.

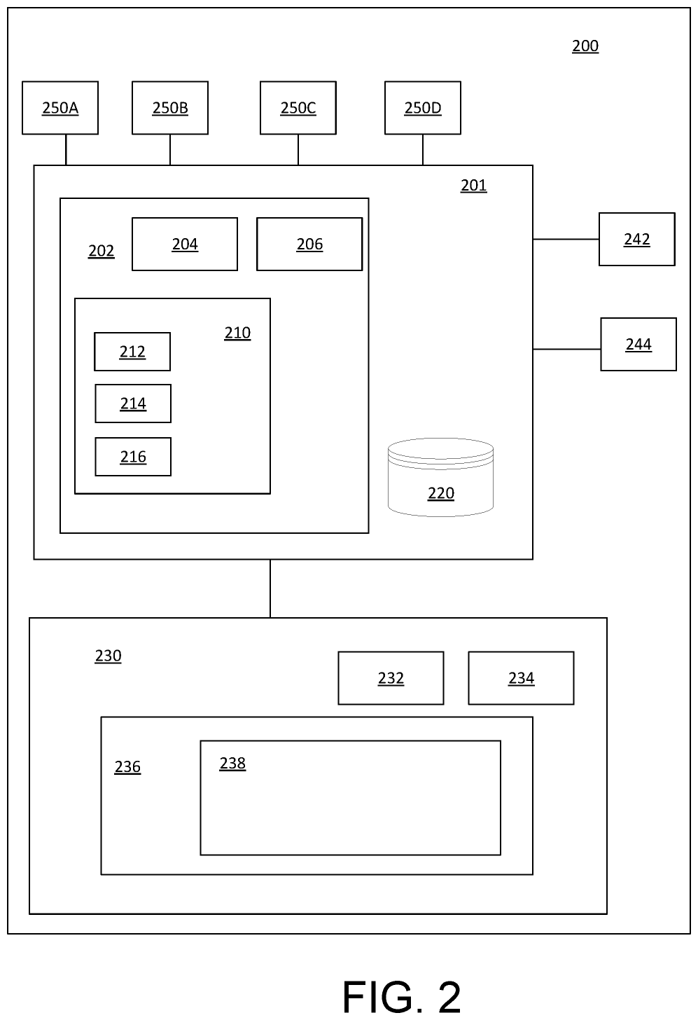

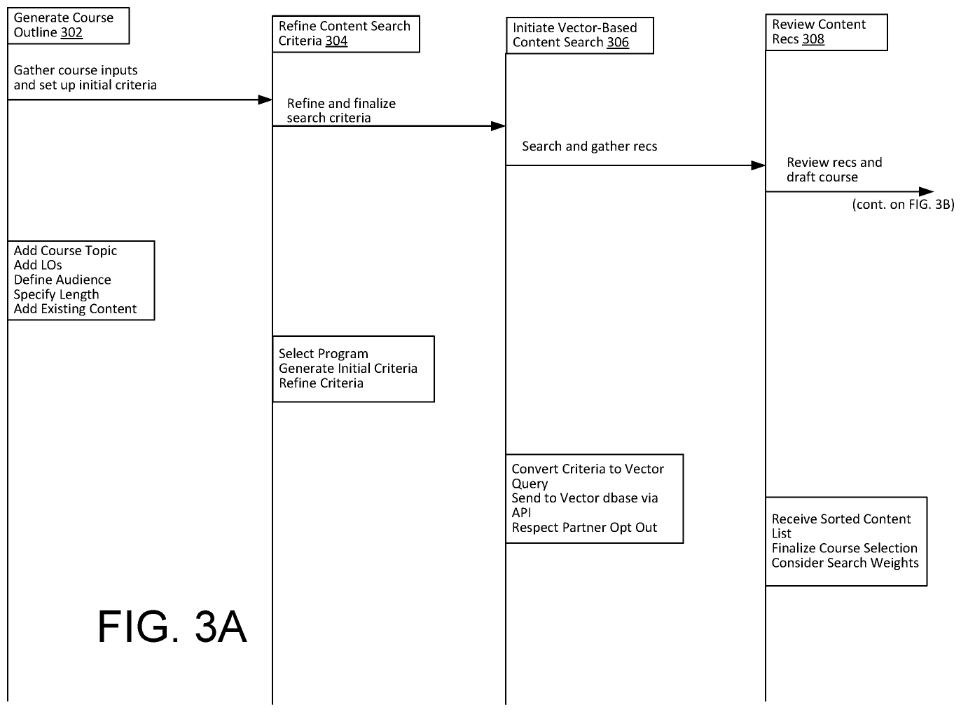

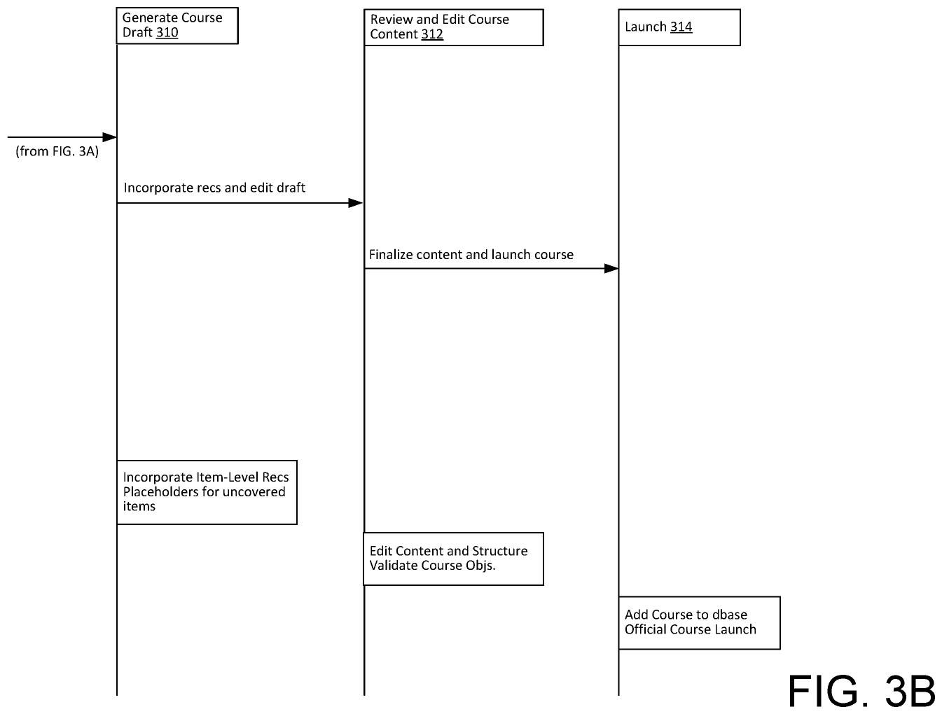

FIG. 2 is a schematic block diagram of a system 200 for creating an educational course to be provided to a plurality of learners from an online learning platform 201. The system 200 includes one or more computing devices 202 that provide the resources for the online learning platform 201 from which the courses are provided to learners. The one or more computing devices 202 each can include one or more processors 204 and one or more memory devices 206. The memory devices 206 can store executable instructions that can be executed by the one or more processors 204 to provide the functionality described herein.

The one or more computing devices 202 of the online learning platform 201 can maintain a large number of courses (e.g., thousands, or hundreds of thousands, of courses) in one or more database repositories 220. The courses can be provided by the online learning platform 201 to computing devices of learners, so that the learners can access the courses remotely. The courses need not be, and generally are not, created by owner of the online platform. Rather, the courses generally are created and/or owned by academic institutions, companies, academicians, and individuals and then are provided to the online platform, so that the courses can be provided by the online learning platform 201 to a large number of learners who are associated with the online platform. Thus, having a central store of courses in the online learning platform 201 can provide course creators with an opportunity to reach a large number of learners and can provide learners with an opportunity to access a large number of courses. In some implementations, a course creator or course owner may contract with the owner of the online learning platform 201 to provide a course through the online learning platform 201 and, as part of the contract, may permit portions of the course to be re-used in other courses.

Learners can access the courses provided from the online learning platform 201 through respective computing devices 250A, 250B, 250C, 250D that are controlled by, or otherwise associated with, one or more learners.

A course creator can make use of the client computing device 230 to access resources of the online learning platform 201 to create an educational course that can be maintained on the online learning platform 201 and provided to a plurality of users associated with the online platform. The client computing device 230 can include one or more processors 232 and one or more memory devices 234. The memory devices 234 can store executable instructions that can be executed by the one or more processors 232 to provide functionality described herein. The client computing device 230 can include a course creation module 236 that may provide a user interface 238 through which the course creator interacts with the course creation module and accesses resources of the online platform, including resources of, and associated with, the one or more computing devices 202. For example, the course creation module 236 may permit the course creator to search for existing course content in the one or more database repositories 220 and to integrate the existing course content into a new course created through the course creation module 236.

In some implementations, the course creator can input, through the course creation module 236, to the one or more computing devices 202 of the online platform, a relatively small amount of information about the course that the creator wishes to create, which then is used to create a complete educational course by leveraging the content in existing courses stored within the database repositories 220 of the online platform.

In some implementations, the one or more computing devices 202 can include a course generation module 210 that receives the input from the course creator about the course that the creator wishes to create. The course generation module 210 includes an outline generator 212 that is configured to generate, based on the input information provided by the course generator, a proposed outline of the educational course the course creator desires to create. The course generation module 210 includes a query generator that is configured to generate search terms and keywords based on the proposed outline of the educational course. The generated search terms and keywords then can be used to search the database repositories 220 for course content that matches the search terms and keywords. The course generator 210 further includes a content synthesizer 216 that receives at least a subset of the course content retrieved in response to the generated search terms and keywords and synthesizes the course content into an educational course.

As explained in more detail herein, the components 212, 214, 216 of the course generation module 210 can make use of large language models and generative AI tools. For example, the outline generator 212 can provide one or more prompts, based on the input information from the course creator, to a first LLM 242, which generates the proposed outline for the educational course. The outline can include a plurality of modules for the educational course and descriptions of the modules, where each description of a module includes one or more learning objectives for the module. In another example, the content synthesizer 216 can provide one or more prompts, based on the content of the course content retrieved in response to the generated search terms and keywords, to a second LLM 244, which then organizes the course content to generate the educational course. The second LLM 224 can be the same as the first LLM 242 or can be a different LLM. In other implementations, more than two LLMs can be used. Example LLMs include GPT-3.5-turbo, GPT-3.5-turbo-16k, GPT4, GPT-4-32k, and GPT-4-turbo. 3A and 3B are an example schematic diagram of a workflow 300 for creating an educational course by using LLMs to retrieve course content from existing courses within database repositories of an online learning platform 201 and to integrate the retrieved content to create the course.

In the first step 302 of the workflow 300, a preliminary course outline for an educational course that an author seeks to create is generated. Within the first step 302, a course generator of the online learning platform 201 receives information from the author about the educational course that the author seeks to generate. Information can include, for example: a topic for the course, a target audience for the course (e.g., a target skill level, such as, for example, high school freshman, college students, graduate students, professionals with a certain number of years of experience with a particular topic, etc.), one or more learning objectives for the course, and/or a target duration (e.g., in terms of time or in terms of number of modules or units of the course) for the course. In addition, the author can provide existing content, for example, text files, PDF files, graphical files, audio files, video files, etc., for use in the educational course or to provide context for use in creating the educational content of the course. For example, the course generator of the online learning platform may receive the information of Table 1 from a course author when prompted by the course generator to enter information about a course topic, course audience, course learning objectives, and target number of modules for the course.

```
TABLE 1
    Course Topic: “This course is an introduction to the fundamental concepts
of Greek Philosophy and the key figures that impacted it. It explores the origins of
Western Philosophy and its development from the Pre-Socratic period to the
Classical period. This course shall imbue the students with philosophical outlook
and acquaint them with the main ideas, themes, and methods of Greek
Philosophy.”
    Course Audience: “College Freshmen”
    Course learning objectives:
```

| | |
|---|---|
| ● | Explain the fundamental ideas of Greek Philosophy. |
| ● | Analyze the contributions of Pre-Socratic thinkers. |
| ● | Interpret the ideas of the Sophists and their critique of traditional Greek |
| | ethics. |
| ● | Describe Socrates' philosophy and his claim to knowledge. |
| ● | Discuss the philosophy of Plato, including the theory of Forms, the |
| | immortality of the soul, and ethical theory. |
| ● | Analyze the work of Aristotle and his contributions to metaphysics, |
| | epistemology, and politics. |
| ● | Articulate the significance of Greek Philosophy in contemporary thought. |

Target Number of Modules: “5”

Based on the information received from the course author, the course generator of the online learning platform can generate a preliminary outline of the course. The preliminary outline can be generated by prompting an LLM to generate the preliminary outline based on the received information. The LLM also can be prompted to generate the preliminary outline with a number of modules, where the modules are ordered from form the least complex topic and towards more complex topics, and such that each module has a clear theme and the set of learning objectives it covers are related to each other, and such that related modules should be next to each other in the progression of the course and that each module should clearly follow from the one before it. In addition, the LLM also can be prompted to generate the preliminary outline such that all learning objectives for the course are taught by a module, that the total number of modules included in the course matches the number of modules specified by the author's input, and such that descriptions created by the LLM for each module are as engaging as possible to get learners excited about the content of the module, rather than merely restating the learning objectives for the module. In some implementations, the LLM is prompted to generate the preliminary outlines such that the outline adheres to a taxonomy (e.g., Bloom's Taxonomy, see e.g., https://tips.uark.edu/using-blooms-taxonomy/, which is incorporated herein by reference) that classifies the learning objectives by complexity and specificity and in which content of each module is ordered according to increasing levels of complexity.

Based on the problems provided to the LLM, the LLM can output an outline for the course that includes the number of modules specified by the author's input, along with a description of each module. For example, the LLM may output the outline shown in Table 2.

```
TABLE 2
  1. Module 1: Introduction to Greek Philosophy
        - This module will set the stage for the course, introducing the students to the
  fundamental ideas of Greek Philosophy. It will provide a broad overview of the
  subject and its significance in contemporary thought.
  2. Module 2: Pre-Socratic Philosophy
        - This module will delve into the contributions of Pre-Socratic thinkers. It will
explore their ideas and how they laid the groundwork for the philosophers that
followed.
  3. Module 3: The Sophists and Socrates
  - This module will introduce the Sophists and their critique of traditional Greek
  ethics. It will also cover Socrates' philosophy and his claim to knowledge.
  4. Module 4: Plato's Philosophy
      - This module will focus on the philosophy of Plato, including the theory of
  Forms, the immortality of the soul, and ethical theory.
    5. Module 5: Aristotle's Philosophy
    - The final module will analyze the work of Aristotle and his contributions to
  metaphysics, epistemology, and politics.
```

Furthermore, in some implementations, the LLM can output a more detailed outline in a structured data format, which includes a description in one or more learning objectives for each module. The format can include learning objectives provided directly by the author and also learning objectives that are generated by the LLM in response to the prompts provided to the LLM. The structure of the outline can be selected to ensure that each module builds on the previous module, starting with the least complex topic and gradually moving towards more complex topics and also can ensure that all learning objectives are covered by the end of the course.

For example, the LLM can output the JSON structured data of Table 3.

TABLE 3

```
  ‘‘‘json
  [
    {
      ″name″: ″Introduction to Greek Philosophy″,
      ″description″: ″Embark on a journey through time as we
explore the origins and significance of Greek Philosophy. This
module will set the stage for the rest of the course, providing a
broad overview of the subject and its relevance in contemporary
thought.″,
      ″learningObjectives″: [
        ″Explain the fundamental ideas of Greek Philosophy.″,
        ″Articulate the significance of Greek Philosophy in
contemporary thought.″
      ]
    },
    {
      ″name″: ″Pre-Socratic Philosophy″,
      ″description″: ″Dive into the minds of the Pre-Socratic
thinkers, the pioneers of Western Philosophy. This module will
explore their groundbreaking ideas and how they laid the
foundation for the philosophers that followed.″,
      ″learningObjectives″: [
        ″Analyze the contributions of Pre-Socratic thinkers.″
      ]
    },
    {
      ″name″: ″The Sophists and Socrates″,
      ″description″: ″Meet the Sophists, the controversial
educators of ancient Greece, and Socrates, the father of Western
Philosophy. This module will delve into their philosophies, their
critiques of traditional Greek ethics, and Socrates' unique claim
to knowledge.″,
      ″learningObjectives″: [
        ″Interpret the ideas of the Sophists and their
critique of traditional Greek ethics.″,
        ″Describe Socrates' philosophy and his claim to
knowledge.″
      ]
    },
    {
      ″name″: ″Plato's Philosophy″,
      ″description″: ″Step into the world of Plato, a student
of Socrates and a teacher of Aristotle. This module will explore
his profound philosophy, including his theory of Forms, his
belief in the immortality of the soul, and his ethical theory.″,
      ″learningObjectives″: [
        ″Discuss the philosophy of Plato, including the
theory of Forms, the immortality of the soul, and ethical
theory.″
      ]
    },
    {
      ″name″: ″Aristotle's Philosophy″,
      ″description″: ″Discover Aristotle, the man who shaped
Western thought for centuries to come. This module will analyze
his extensive work and his significant contributions to
metaphysics, epistemology, and politics.″,
      ″learningObjectives″: [
        ″Analyze the work of Aristotle and his contributions
to metaphysics, epistemology, and politics.″
      ]
    }
  ]
  ‘‘‘
```

In some implementations, the author can provide their own existing content to be included in the educational course, and the LLM can be prompted to generate the preliminary outline based, at least in part, on the existing content provided by the author. For example, the author can provide one or more content items, each having their own descriptors that may include, for example, a unique file identifier, a file type, a name, a summary, etc., and the LLM can refine the preliminary outline based on the provided content. In addition, the LLM can associate each item provided by the author for inclusion in the educational course with a module of the outline, so that the item will be included in the educational course as part of its associated module. The LLM can associate a provided item with a particular module of the course based on a ranking of the relevance of the content item in relation to the modules of the course.

Once the preliminary outline has been generated by the LLM and provided to the author, the author is provided with the opportunity to edit the outline, for example, to refine the descriptions of the modules and the learning objectives associated with the modules.

Next, once the author has finalized the outline, at step 304 of the workflow 300, the outline can be used to generate search criteria that will be used later in the workflow to identify content items in the database of the online learning platform for use in the educational course that the author is creating.

The LLM can be instructed to generate search criteria for finding courses in the database repositories of the online learning platform, where the search criteria are designed to find courses that address the learning objectives of the course that is being created. For example, the LLM can be instructed to generate search criteria for finding courses based on the information shown in Table 4, including prompts about the target audience for the course, the topics for the course, and the learning objectives for the course.

```
TABLE 4
  Target Audience: “College Freshmen”
  Topics: “This course is an introduction to the fundamental concepts of Greek
Philosophy and the key figures that impacted it. It explores the origins of Western
Philosophy and its development from the Pre-Socratic period to the Classical period. This
course shall imbue the students with philosophical outlook and acquaint them with the
main ideas, themes, and methods of Greek Philosophy.”
  Learning Objectives:
```

| | |
|---|---|
| ∘ | Explain the fundamental ideas of Greek Philosophy. |
| ∘ | Analyze the contributions of Pre-Socratic thinkers. |
| ∘ | Interpret the ideas of the Sophists and their critique of traditional Greek |
| | ethics. |
| ∘ | Describe Socrates' philosophy and his claim to knowledge. |
| ∘ | Discuss the philosophy of Plato, including the theory of Forms, the |
| | immortality of the soul, and ethical theory. |
| ∘ | Analyze the work of Aristotle and his contributions to metaphysics, |
| | epistemology, and politics. |
| ∘ | Articulate the significance of Greek Philosophy in contemporary thought. |

In response to the above prompts to the LLM, the LLM can generate the search criteria of Table 5 for searching the database repositories for relevant course content, where the criterion can include a query phrase, the difficulty level, and a subject matter category.

TABLE 5

```
    ‘‘‘json
    [
      {
        ″query″: ″Introduction to Greek Philosophy″,
        ″difficulty″: [″Beginner″],
        ″subject″: [″Arts and Humanities″]
      },
      {
        ″query″: ″Pre-Socratic Philosophy″,
        ″difficulty″: [″Beginner″],
        ″subject″: [″Arts and Humanities″]
      },
      {
        ″query″: ″Sophists and Greek Ethics″,
        ″difficulty″: [″Beginner″],
        ″subject″: [″Arts and Humanities″]
      },
      {
        ″query″: ″Socrates' Philosophy and Knowledge″,
        ″difficulty″: [″Beginner″],
        ″subject″: [″Arts and Humanities″]
      },
      {
        ″query″: ″Plato's Philosophy and Theory of Forms″,
        ″difficulty″: [″Beginner″],
        ″subject″: [″Arts and Humanities″]
      },
      {
        ″query″: ″Aristotle's Metaphysics, Epistemology, and
Politics″,
        ″difficulty″: [″Beginner″],
        ″subject″: [″Arts and Humanities″]
      },
      {
        ″query″: ″Significance of Greek Philosophy in
Contemporary Thought″,
        ″difficulty″: [″Beginner″],
        ″subject″: [″Arts and Humanities″]
      }
    ]
  ‘‘‘
```

In some implementations, as a preliminary step for using the course outline to generate search criteria, the overall learning objectives of each module of the course outline can be divided, as desired or needed, into item-level learning objectives, so that the item-level learning objectives can be used to search for individual items in the course database of the online learning platform.

For example, the LLM can be prompted with a topic of the course, the target audience for the course, a description of a module in the course (including, for example, one or more overall learning objectives for the module), and a total number of item-level learning objectives for the module. The total number of item-level learning objectives the module can be provided manually by the author or can be provided by the LLM in response to previous inputs to the LLM about the topic, target audience, learning objectives, and number of modules for the course.

In some implementations, for each overall learning objective of the provided module, the LLM can decompose that learning objective into one or more item-level learning objectives that a learner would need to achieve understanding of an overarching module-level learning objective. Each item-level learning objective can be granular enough, such that it can be covered by a single content item of a course, such as, for example, an individual lecture or reading assignment. The number of item-level learning objectives need not be the same for all modules of the course, but rather more complex module-level learning objectives can have more item-level learning objectives than simpler ones.

As an example, the information shown in Table 6, including a topic of the course, a target audience for a course, and a structured data description of a module of the course, where the description of the module includes three learning objectives, can be input to an LLM, along with the requirement that the total number of level learning objectives for the module should be seven.

```
TABLE 6
Course Topic: ″This course is an introduction to the fundamental concepts of
Greek Philosophy and the key figures that impacted it. It explores the origins of
Western Philosophy and its development from the Pre-Socratic period to the
Classical period. This course shall imbue the students with philosophical outlook
and acquaint them with the main ideas, themes, and methods of Greek
Philosophy.″
Course Audience: ″College Freshmen″
Course Module:
Total number of item-level learning objectives for the module: 7
‘‘‘json
  {
    ″name″: ″Socratic Philosophy and the Sophistic
Discussion″,
      ″description″: ″Engage with the philosophy of Socrates,
his claim to knowledge and encounter the revolutionary
ideas introduced by the Sophists.″,
      ″learningObjectives″: [
        {
          ″learningObjective″: ″Interpret the ideas of the
Sophists and their critique of traditional Greek ethics.″
        },
        {
          ″learningObjective″: ″Describe Socrates' philosophy
and his claim to knowledge.″
        }
      ]
  }
‘‘‘
```

Then, based on this input to the LLM, the LLM can generate seven item-level learning objectives for the module shown in Table 7, where the learning objectives are shown in a structured data format and in association with their parent module-level learning objectives:

TABLE 7

```
    ‘‘‘json
    [
      {
        ″name″: ″Socratic Philosophy and the Sophistic
Discussion″,
        ″description″: ″Engage with the philosophy of Socrates,
his claim to knowledge and encounter the revolutionary ideas
introduced by the Sophists.″,
        ″learningObjectives″: [
          {
            ″learningObjective″: ″Interpret the ideas of the
Sophists and their critique of traditional Greek ethics.″,
            ″itemLevelLearningObjectives″: [
              ″Identify the main figures of the Sophistic
movement and their contributions.″,
              ″Explain the Sophists' critique of traditional
Greek ethics.″,
              ″Analyze the impact of Sophistic ideas on Greek
society and philosophy.″
            ]
          },
          {
            ″learningObjective″: ″Describe Socrates' philosophy
and his claim to knowledge.″,
            ″itemLevelLearningObjectives″: [
              ″Outline the key principles of Socratic
philosophy.″,
              ″Explain Socrates' method of inquiry and his
claim to knowledge.″,
              ″Discuss the implications of Socratic philosophy
for ethics and knowledge.″,
              ″Analyze the reasons for Socrates' trial and
execution.″
            ]
          }
        ]
      }
    ]
  ‘‘‘
```

The course author can be provided with an opportunity to revise the search criteria that are received from the LLM. Once the search criteria are finalized by the course author, then, at step 306 of the workflow 300, the search criteria can be vectorized and executed as a vector query on the database repositories of course content that is maintained by the online platform. The ranking algorithm used to execute the vector query can find a sufficient number of courses in the database repositories that cover all of the learning objectives, while favoring courses that cover several learning objectives. In addition, the search results can be ranked according to a target audience associated for the course, so as to find courses that match audience and the complexity of the learning objective for which the content is sought.

Ranked results of the search query can be gathered and provided to the course author through a user interface, where the results provide recommended sources of course content for the course that the author is creating. The results can include existing courses stored on the online learning platform, which the owners of the courses have designated as being valid sources of content that can be used in courses.

At step 308 of the workflow 300, the course author can review the recommended sources of course content, can delete particular recommendations as candidates for course content, and/or can add additional sources of course content. For example, an author can search for additional sources of course content by searching the database using manually generated search queries (e.g., manually generated search queries for a particular course name, educator, or institution associated course).

Once the sources of content are finalized, then, at step 310 of the workflow 300, an LLM can be prompted to generate recommendations of course content pulled from the sources to teach each item-level learning objective included in the outline for the course. The prompts to the LLM can include the sources of content, the course outline (including its module-level and item-level learning objectives and descriptions of the modules and items), and the target audience for the course.

In some implementations, to assemble item-level course content into a module for a course, the LLM can be prompted with a number of inputs to help the LLM create the module, such as, for example: the target audience of the new course, the name of the module in the new course, the description of the module, the target duration of the module in minutes, module-level learning objectives that module should achieve as a whole, item-level learning objectives that individual items in the module should achieve, the learning objectives that are covered by earlier modules in the course, the learning objectives that are covered in later modules in the course, a list of potential items to include in the course.

When selecting and ordering content items in the new course, the LLM can be prompted to select and include items that fit the theme and learning objectives of the module, items that are appropriate for the course's audience, items that use the course's primary language. The LLM further can be prompted to avoid including items that are redundant with learning objectives that have already been covered in the course, and to avoid including items that would better fit learning objectives that will be covered later in the course.

In addition, the LLM can be prompted to keep items or sets of items from the same original source course next to each other in the new course and in their order maintained in the original sources. In addition, the LLM can be prompted to selected and include items for modules, so that the module tells a clear narrative, starting with the least complex item and building towards more complex items, and so that related items are next to each other within a module and that each item clearly follows from the one before it.

Furthermore, the LLM can be prompted to select and include content items for inclusion in a module, so that the time it should take to complete a module is within a threshold range of the target duration of the module (e.g., within 5% of the target duration for the module, within 10% of the target duration for the module, within 20% of the target duration for the module), unless there really are no more items that would fit in the module.

At step 312 of the workflow 300, the recommendations of course content pulled from the sources to teach each item-level learning objective can be provided to the author for review, for example, in a user interface that allows the author to review the details of the recommended content, such as, for example, the description of the content, and the content itself. If the LLM cannot locate content within the sources that sufficiently matches an item-level learning objective, then a placeholder for such can be listed, so that the required content can be added by the author or deleted from the module.

The content items selected and posed by the LLM for teaching the learning objectives of the new course can be reviewed and revised by the author, for example, in a user interface with which the author interacts with the proposed content. For example, the user interface can provide a summary of the content, the name of the source course and institution or educator for the content, the length of the content, and other such descriptive metadata. In addition, the user interface can enable the opportunity to review the content itself, for example, by clicking a link to play video content within the user interface or to display text content within the user interface. The user interface can permit the author to reorder the proposed content in the new course, to delete proposed content, and/or to add additional content for the proposed course.

In addition, the author can use the user interface to generate new content for the course, such as, for example, (quizzes, homework assignments, coding exercises, problem sets, etc.). In some implementations, the author can invoke an LLM through the user interface to process the selected content for the course and to generate such new content based on the selected content. The author then may review and edit the newly-generated content and select or reject it for inclusion in the course.

Once the author is satisfied with the content for the new course, the course can be finalized by processing the course content to create a course that fits the technical standards of the online learning platform. At step 314 of the workflow 300, the course can be added to the database repository of courses offered by the online learning platform and offered to learners of the platform.

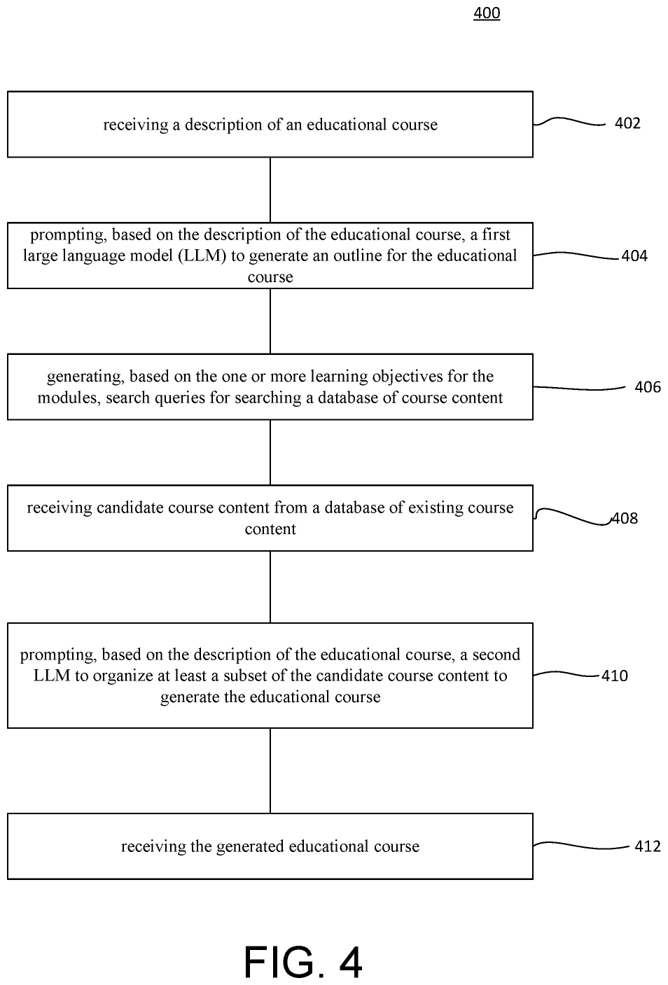

FIG. 4 is a flowchart of a process 400 that includes receiving a description of an educational course (402), and prompting, based on the description of the educational course, a first large language model (LLM) to generate an outline for the educational course (404). The outline includes a plurality of modules for the educational course and descriptions of the modules, and each description of a module of the plurality of modules includes one or more learning objectives for the module. The process 400 further includes generating, based on the one or more learning objectives for the modules, search queries for searching a database of course content (406), and receiving candidate course content from a database of existing course content (408), where the candidate course content is responsive to the search queries being executed on the database. The process further includes prompting, based on the description of the educational course, a second LLM to organize at least a subset of the candidate course content to generate the educational course (410), and receiving the generated educational course (412).

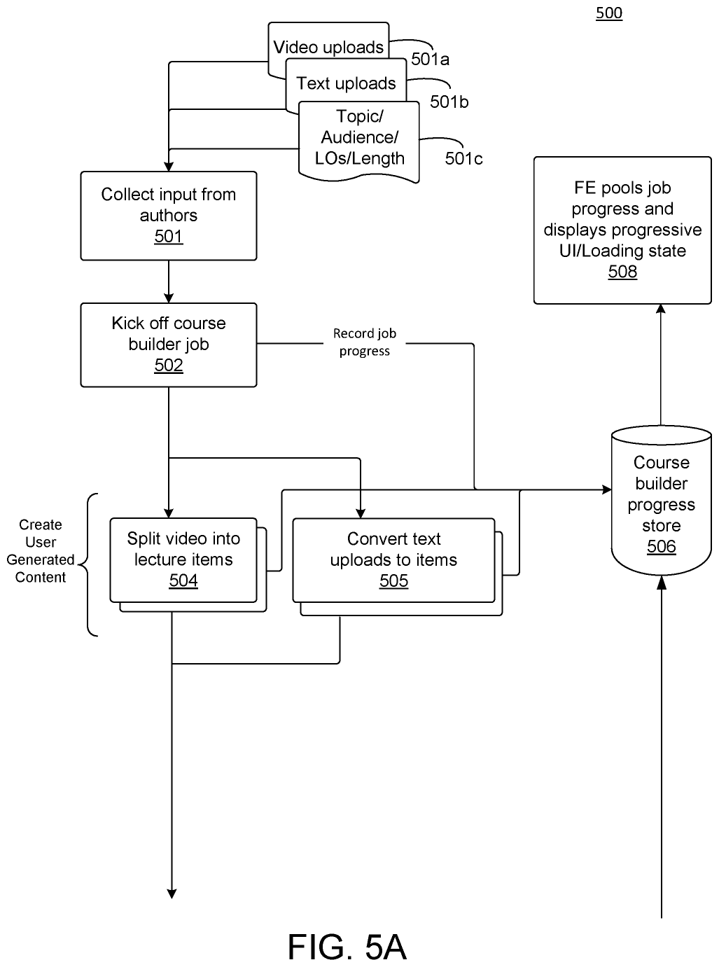

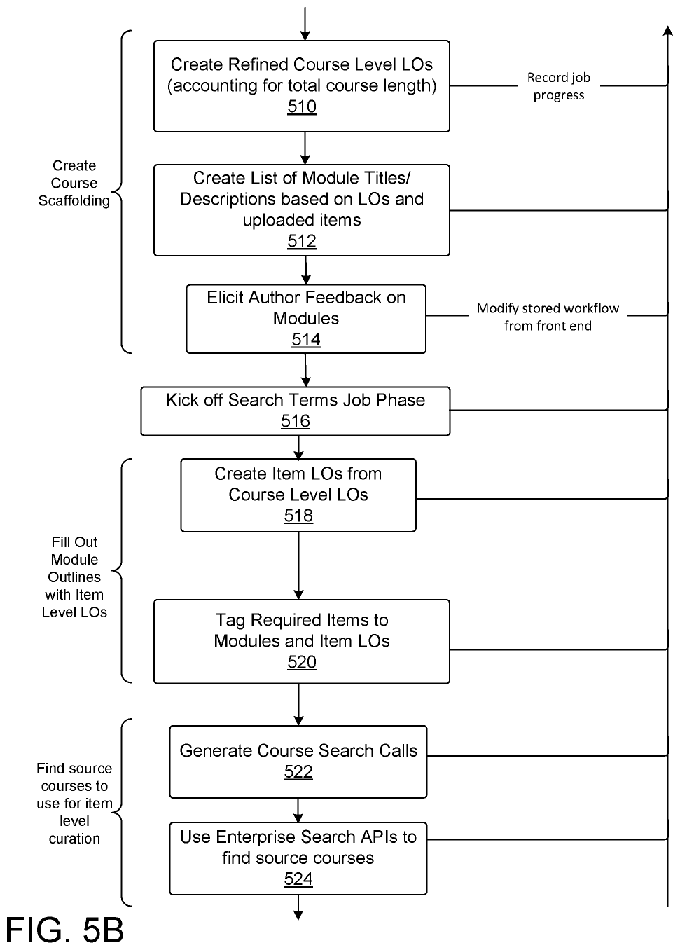

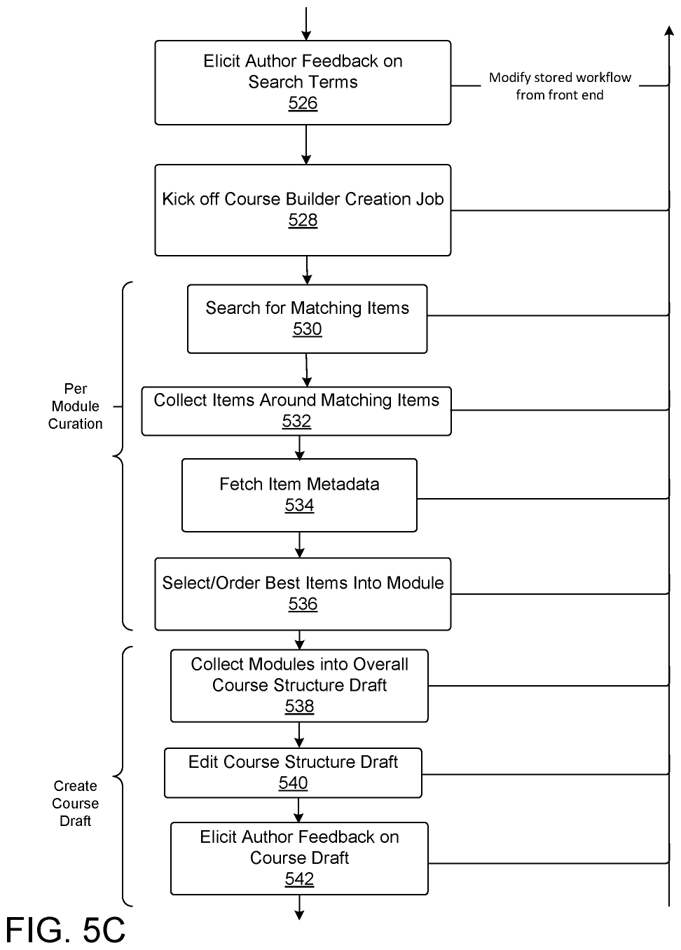

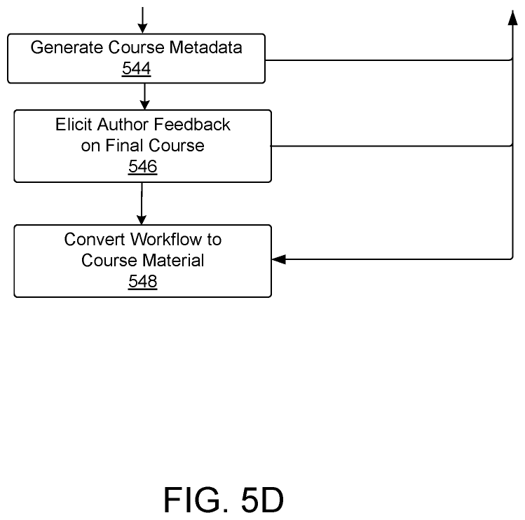

FIGS. 5A-5D show a flowchart of a process 500 for authoring content of a customized educational course by using LLMs to retrieve course content from existing courses within database repositories of an online learning platform and to integrate the retrieved content to create the course, according to techniques described herein. The process 500 can be implemented by a system, such as system 200, that includes a course generation module of an online learning platform and that makes use of one or more LLMs that provide generative AI functionality.

Process 500, at stage 501, includes a frontend process that includes collecting input from an author. The collected input may, for example, include video uploads 501a, text uploads 501b, and input about a topic of the course, the target audience for the course, learning objectives for the course, and a target duration for the course 501c.

Process 500 may further include, at stage 502, a backend process for kicking off (i.e., launching) a course builder job. At stage 504, an LLM can be prompted to perform a generative AI process for splitting uploaded video content into lecture items for use as course content, and at stage 505, the LLM can be prompted to perform a generative AI process for converting text uploads into items for use as course content. The LLM can the prompted to split and convert the items based on pedagogical best practices for the course, including, for example, creating items of lengths that are suitable for the course and that are broken down by levels of complexity. A course builder progress store 506 can store data about the progress of the course builder job, and a frontend tool 508 can pool job progress data and process that data, to provide information to the author through a user interface about progress of the workflow for creating the educational course.

Process 500 continues at stage 510 by prompting an LLM to perform a generative AI process for creating a refined list of course-level learning objectives. As described herein, the course-level learning objectives can be based on input received from the author, for example, information about the course topic, learning objectives input by the author, a target audience for the course, a target duration for the course, and content items provided by the author.

Next, at stage 512, an LLM can be prompted to perform a generative AI process for creating a module-level outline for the course that includes a list of module titles and descriptions of the modules based on the learning objectives generated in stage 510 and based on content items provided by the author.

At stage 514, a front-end process of the content generation module can elicit feedback from the author on the module-level outline for the course. For example, the author may edit the titles and descriptions of the modules and/or the learning objectives for the modules. Based on the feedback from the author, upstream steps of the workflow can be repeated to refine the module-level outline for the course.

At stage 516, a backend process can kickoff a process for searching for existing course content within database repositories of an online learning platform based on information generated in upstream steps of the workflow.

At stage 518, as described above, an LLM can be prompted to perform a generative AI process for creating item-level learning objectives based on course-level and module-level learning objectives generated in upstream steps of the workflow.

At stage 520, an LLM can be prompted to perform a generative AI process for tagging any content items that have been specified by the author as being required for inclusion in the educational course to a particular module or modules of the generated course outline and to one or more item-level learning objectives. This can ensure that content items required by the author are included in the course at the most logical place from a pedagogical perspective.

At stage 522, an LLM can be prompted, based at least in part on the item-level learning objectives, to perform a generative AI process for generating search terms, keywords, and/or search queries. The LLM can return the search terms, keywords, and/or search queries to the content generation module of the online learning platform, which can use the returned information to execute queries, at stage 524, in a backend process to retrieve courses from the database repositories of the online learning platform, which are responsive to the search queries.

At stage 526, a front-end process of the content generation module can elicit feedback from the author on the search criteria that were generated. For example, the author may edit or add search terms, keywords, and particular queries. Based on the feedback from the author, upstream steps of the workflow can be repeated to refine the search criteria used to search for content into rerun the search.

At stage 528, a backend process can kickoff a process for building an educational course based on the course content items in the courses responsive to the search queries executed at stage 524 and based on content uploaded by the author for inclusion in the course.

At stage 530, a backend process executed by a course generation module can execute a search for individual course content items that match search criteria that are based on item-level information, such as, for example, search criteria based on item-level learning objectives and descriptions. Individual course content items matching the search criteria can be returned, and, at stage 532, course content items related to the matching course content items can be collected. For example, if a lecture content item from a particular course matches the search criteria and is returned, then, for example, a slide deck used in the lecture, a quiz provided in the course sequence soon after the lecture, a reading assigned before the lecture, etc. can be collected as items related to and around the matching lecture content item.

At stage 534, a backend process can fetch metadata associated with course content items that are collected in response to the search. The metadata can include for example, learner-generated rankings and/or reviews of the content items or the course they are contained in, a popularity of the content item as measured by a number of learners who have taken the course that includes the content item, or that have completed the course, or who have dropped out of the course before completing the course.

At stage 536, an LLM can be prompted, based at least in part on content of the collected course content items, inputs about the target audience, course length, module-level and item-level learning objectives, and pedagogical best practices, to select and order course best content items for each module of the course.

At stage 538, a backend process can organize the best content items for modules of the course into an overall course structure draft, and at stage 540, an LLM can be prompted to edit the course structure draft, for example, to flag the occurrence of duplicate or missing content items in the draft for a particular item-level learning objective for to flag the existence of any required content items uploaded by the author that are missing from the course structure draft. Thus, based on the availability of course content items responsive to the initial course structure draft, the LLM can be prompted to modify the course structure draft to best achieve the goals of the author, given the course content items that are available. Then, based on the modified course structure draft, other upstream steps of the workflow can be rerun.

At stage 542, a front-end process can elicit author feedback on the course draft. For example, the author may edit, add, or delete course content items that have been suggested for the course, and can edit, add, or delete module-level and item-level learning objectives for the course. Based on the feedback from the author, upstream steps of the workflow can be repeated to prepare a modified draft course structure.

Once the author is satisfied with the draft course structure and the content items associated with the draft course, an LLM can be prompted, at stage 544, to generate metadata and/or additional content items for the course. For example, the LLM can be prompted to generate course title, an engaging description of the course and its modules and learning objectives, and keywords that can be associated with the course that may be used to respond to search queries by learners looking for a course about a particular topic or addressing one or more particular learning objectives. In addition, an LLM can be prompted to generate additional course materials, such as, for example, quizzes, coding exercises, problem sets, surveys, etc., based on the content items for the course.

At stage 546, a front-end process can elicit author feedback on the final course draft, and once the author is satisfied with the final course, at stage 548, the workflow and the course content can be processed to create a course that fits the technical standards of the online learning platform.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
receive a description of an educational course;
prompt, based on the description of the educational course, a first large language model (LLM) to generate an outline for the educational course, the outline including a plurality of modules for the educational course and descriptions of the modules, each description of a module of the plurality of modules including one or more learning objectives for the module;
generate, based on the one or more learning objectives for the modules, search queries for searching a database of course content;
receive candidate course content from a database of existing course content, the candidate course content being responsive to the search queries being executed on the database;
prompt, based on the description of the educational course, a second LLM to organize at least a subset of the candidate course content to generate the educational course; and
receive the generated educational course.

2. The computer program product of claim 1, wherein the description of the course includes a target duration for the course.

3. The computer program product of claim 2, wherein the duration of the generated course has a duration of within a threshold range of the target duration of the course.

4. The computer program product of claim 2, wherein the description of the course further includes one or more of: a topic of the course, a target audience for the course, and learning objectives for the course.

5. The computer program product of claim 1, wherein the first LLM is prompted to generate outlines of educational courses that adhere to a taxonomy that classifies the learning objectives by complexity and specificity and in which content of each module is ordered according to increasing levels of complexity.

6. The computer program product of claim 1, wherein the received candidate course content includes course content that matches one or more of the search queries and parent and/or child course content of the course content that matches the one or more search queries.

7. The computer program product of claim 1, wherein the candidate course content received from the database of existing course content includes candidate course content received from a plurality of separate and distinct courses from the database of existing course content, and wherein the generated educational course includes course content from a plurality of separate and distinct courses from the database of existing course content.

8. The computer program product of claim 1, wherein the second LLM is prompted to generate the educational course that includes the subset of the candidate course content, where the subset of the candidate course content is organized in the generated course according to a taxonomy that classifies learning objectives associated with the candidate course content by complexity and specificity and in which course content of each module of the generated course is ordered according to increasing levels of complexity.

9. A computer-implemented method comprising:
receiving a description of an educational course;
prompting, based on the description of the educational course, a first large language model (LLM) to generate an outline for the educational course, the outline including a plurality of modules for the educational course and descriptions of the modules, each description of a module of the plurality of modules including one or more learning objectives for the module;
generating, based on the one or more learning objectives for the modules, search queries for searching a database of course content;
receiving candidate course content from a database of existing course content, the candidate course content being responsive to the search queries being executed on the database;
prompting, based on the description of the educational course, a second LLM to organize at least a subset of the candidate course content to generate the educational course; and
receiving the generated educational course.

10. The computer-implemented method of claim 9, wherein the description of the course includes a target duration for the course.

11. The computer-implemented method of claim 10, wherein the duration of the generated course has a duration of within a threshold range of the target duration of the course.

12. The computer-implemented method of claim 10, wherein the description of the course further includes one or more of: a topic of the course, a target audience for the course, and learning objectives for the course.

13. The computer-implemented method of claim 9, wherein the first LLM is prompted to generate outlines of educational courses that adhere to a taxonomy that classifies the learning objectives by complexity and specificity and in which content of each module is ordered according to increasing levels of complexity.

14. The computer-implemented method of claim 9, wherein the received candidate course content includes course content that matches one or more of the search queries and parent and/or child course content of the course content that matches the one or more search queries.

15. The computer-implemented method of claim 9, wherein the candidate course content received from the database of existing course content includes candidate course content received from a plurality of separate and distinct courses from the database of existing course content, and wherein the generated educational course includes course content from a plurality of separate and distinct courses from the database of existing course content.

16. The computer-implemented method of claim 9, wherein the second LLM is prompted to generate the educational course that includes the subset of the candidate course content, where the subset of the candidate course content is organized in the generated course according to a taxonomy that classifies learning objectives associated with the candidate course content by complexity and specificity and in which course content of each module of the generated course is ordered according to increasing levels of complexity.

17. A system comprising:
one or more processors;
one or more computer-readable storage devices comprising instructions that, when executed by the one or more processors, cause the system to:
receive a description of an educational course;
prompt, based on the description of the educational course, a first large language model (LLM) to generate an outline for the educational course, the outline including a plurality of modules for the educational course and descriptions of the modules, each description of a module of the plurality of modules including one or more learning objectives for the module;
generate, based on the one or more learning objectives for the modules, search queries for searching a database of course content;
receive candidate course content from a database of existing course content, the candidate course content being responsive to the search queries being executed on the database;
prompt, based on the description of the educational course, a second LLM to organize at least a subset of the candidate course content to generate the educational course; and
receive the generated educational course.

18. The system of claim 17, wherein prompting the first LLM includes prompting the first LLM to generate outlines of educational courses that adhere to a taxonomy that classifies the learning objectives by complexity and specificity and in which content of each module is ordered according to increasing levels of complexity.

19. The system of claim 17, wherein the received candidate course content includes course content that matches one or more of the search queries and parent and/or child course content of the course content that matches the one or more search queries.

20. The system of claim 17, wherein the candidate course content received from the database of existing course content includes candidate course content received from a plurality of separate and distinct courses from the database of existing course content, and wherein the generated educational course includes course content from a plurality of separate and distinct courses from the database of existing course content.
